(19) United States
(12) Patent Application Publication
(10) Pub. No.: US 2026/0162626 A1
(43) Pub. Date: Jun. 11, 2026

(54) LIQUID CRYSTAL DISPLAY DEVICE AND METHOD OF DRIVING LIQUID CRYSTAL DISPLAY DEVICE

(71) Applicant: Sharp Display Technology Corporation, Kameyama City (JP)

(72) Inventor: Osamu SASAKI, Kameyama City (JP)

(21) Appl. No.: 19/293,056

(22) Filed: Aug. 7, 2025

(30) Foreign Application Priority Data
Sep. 11, 2024 (JP) 2024-157642

(51) Int. Cl. G09G 3/36; G02F 1/1362; G02F 1/1368

(52) U.S. Cl. CPC G09G 3/3659; G02F 1/13624; G02F 1/1368; G09G 2320/04; G09G 2330/026; G09G 2330/027; G09G 2330/10

(57) ABSTRACT

A liquid crystal display device comprises a first data line; a plurality of scan lines; and a plurality of pixel circuits each including a transistor and a pixel electrode, wherein in each of the plurality of pixel circuits, the pixel electrode is connected to the first data line via the transistor, and the transistor has a gate electrode connected to any of the plurality of scan lines, and a power-off sequence period includes: a first period in which a simultaneous selection is performed where an active electrical potential is supplied to the plurality of scan lines while a black-gray-level electrical potential is being supplied to the first data line; and a second period in which the black-gray-level electrical potential is supplied to the first data line with the supply of the active electrical potential to the plurality of scan lines being suspended.

### FIELD

The present disclosure relates to liquid crystal display devices.

### BACKGROUND

Japanese Unexamined Patent Application Publication No. 2016-188949 discloses a technique on a power-off sequence for a liquid crystal display device.

### SUMMARY

### Problems to Be Solved by the Invention

Liquid crystal display devices could develop an irregular display (e.g., a bright line) due to a point defect (a defective subpixel) upon turning off or on the power supply.

### Solution to the Problems

The present disclosure is directed to a liquid crystal display device including: a first data line; a plurality of scan lines; and a plurality of pixel circuits each including a transistor and a pixel electrode, wherein in each of the plurality of pixel circuits, the pixel electrode is connected to the first data line via the transistor, and the transistor has a gate electrode connected to any of the plurality of scan lines, and a power-off sequence period includes: a first period in which a simultaneous selection is performed where an active electrical potential is supplied to the plurality of scan lines while a black-gray-level electrical potential is being supplied to the first data line; and a second period in which the black-gray-level electrical potential is supplied to the first data line with the supply of the active electrical potential to the plurality of scan lines being suspended.

### Advantageous Effects of the Disclosure

A liquid crystal display device in accordance with the present disclosure improves an irregular display.

### BRIEF DESCRIPTION OF DRAWINGS

FIG. 1 is a cross-sectional view of an exemplary structure of a liquid crystal display device in accordance with the present embodiment.

FIG. 2 is a schematic diagram of the exemplary structure of the liquid crystal display device in accordance with the present embodiment.

FIG. 3 is a timing chart illustrating a method of driving the present liquid crystal display device.

FIG. 4 is a schematic diagram depicting a method of driving the liquid crystal display device shown in FIG. 2.

FIG. 5 is a schematic diagram of the exemplary structure of the liquid crystal display device in accordance with the present embodiment.

FIG. 6 is a schematic diagram depicting a method of driving the liquid crystal display device shown in FIG. 5.

FIG. 7 is a schematic diagram of a comparative example.

FIG. 8 is a schematic diagram of how a bright line can develop in a comparative example.

FIG. 9 is a timing chart illustrating a method of driving the present liquid crystal display device.

FIG. 10 is a schematic diagram depicting a method of driving the liquid crystal display device shown in FIG. 2.

FIG. 11 is a schematic diagram depicting a method of driving the liquid crystal display device shown in FIG. 5.

FIG. 12 is a schematic diagram of an exemplary structure of a liquid crystal display device in accordance with the present embodiment.

FIG. 13 is a timing chart illustrating a method of driving the present liquid crystal display device.

FIG. 14 is a timing chart illustrating a method of driving the present liquid crystal display device.

FIG. 15 is a schematic diagram of an onboard display device in accordance with the present embodiment.

### DESCRIPTION OF EMBODIMENTS

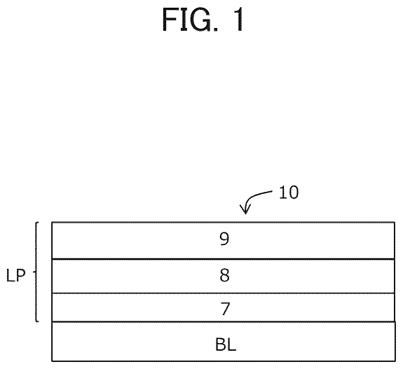

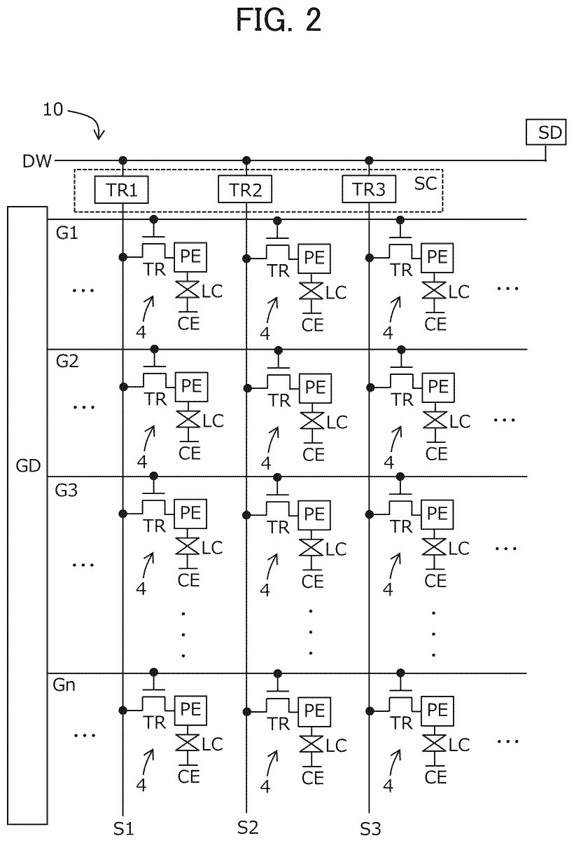

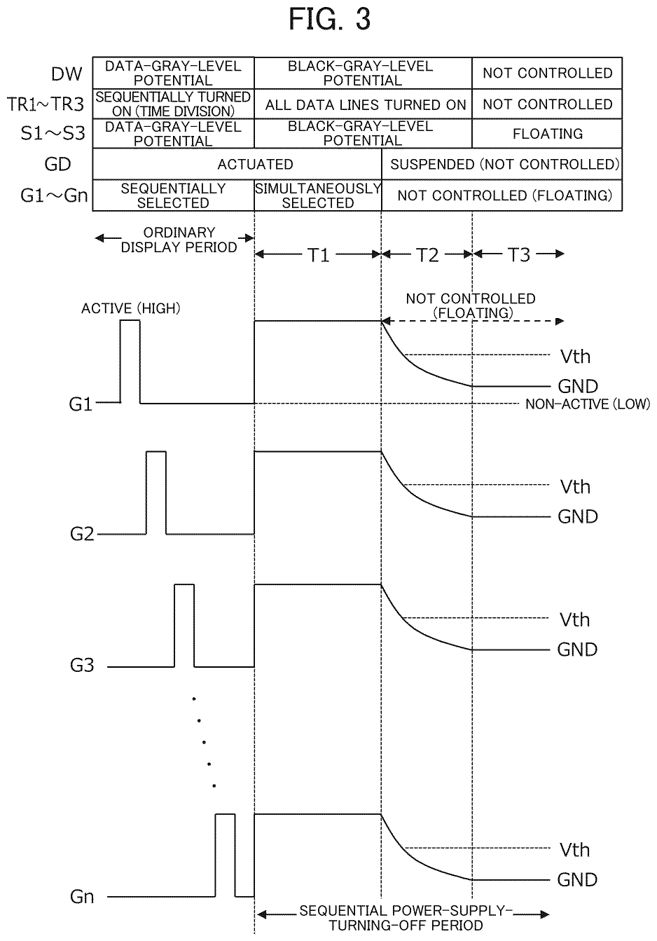

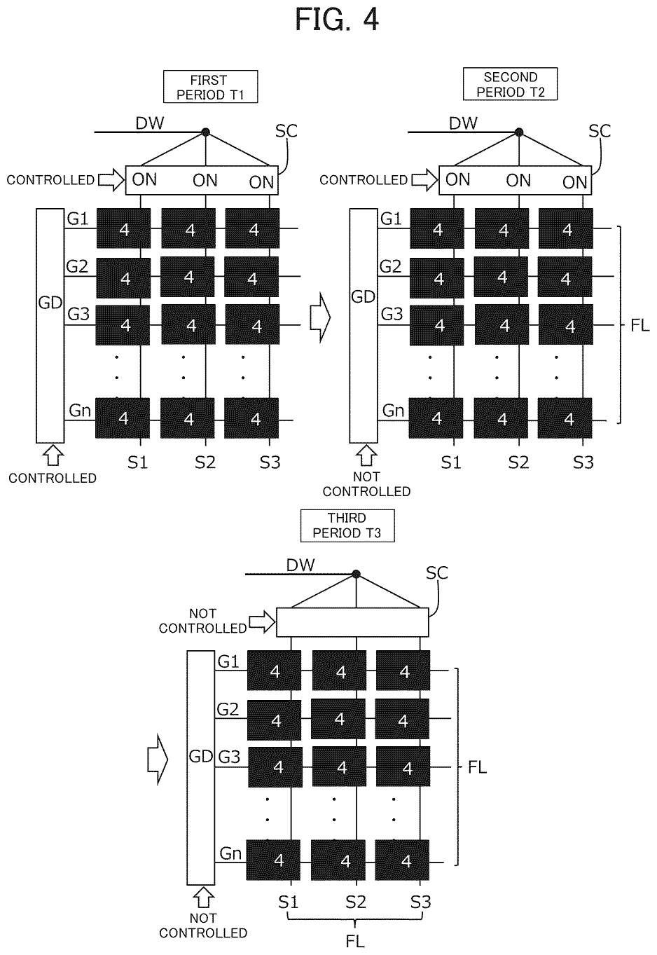

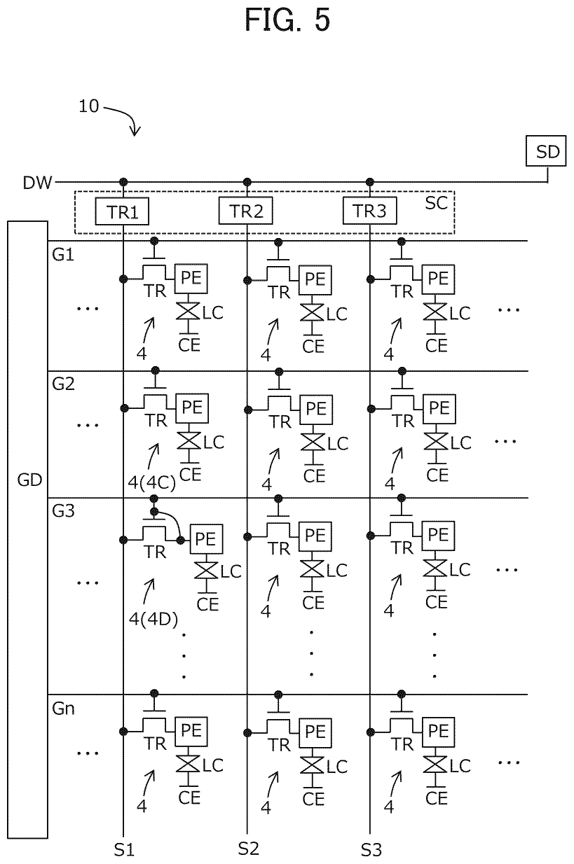

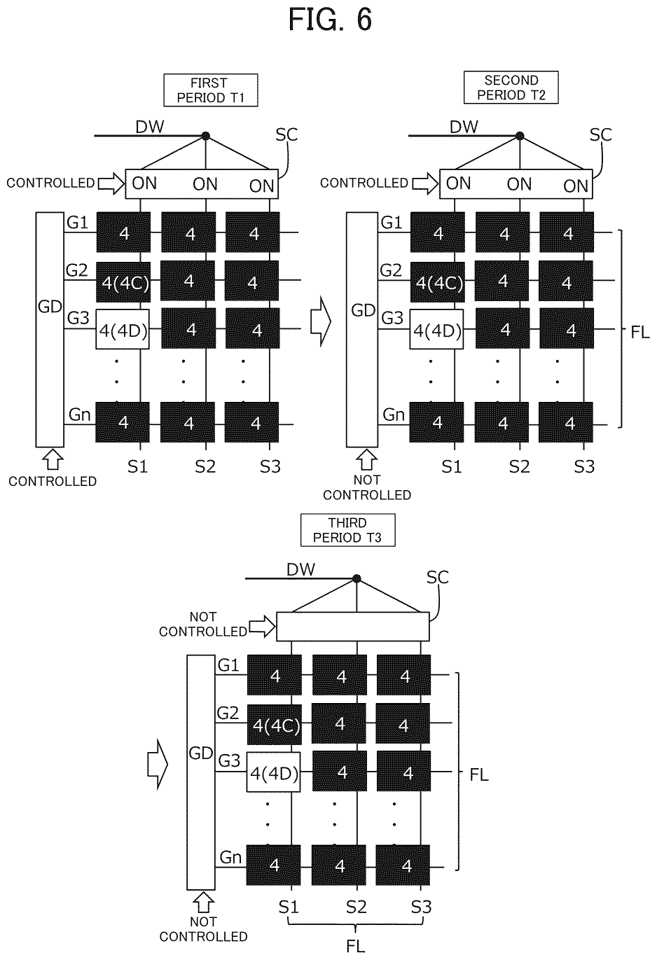

FIG. 1 is a cross-sectional view of an exemplary structure of a liquid crystal display device in accordance with the present embodiment. FIG. 2 is a schematic diagram of the exemplary structure of the liquid crystal display device in accordance with the present embodiment. FIG. 3 is a timing chart illustrating a method of driving the present liquid crystal display device. FIG. 4 is a schematic diagram depicting a method of driving the liquid crystal display device shown in FIG. 2. FIG. 5 is a schematic diagram of the exemplary structure of the liquid crystal display device in accordance with the present embodiment. FIG. 6 is a schematic diagram depicting a method of driving the liquid crystal display device shown in FIG. 5.

Referring to FIGS. 1 to 6, a liquid crystal display device 10 in accordance with the present embodiment includes: a first data line S1; a plurality of scan lines G1 to Gn; and a plurality of pixel circuits 4 each including a transistor TR and a pixel electrode PE. In each pixel circuit 4, the pixel electrode PE is connected to the first data line S1 via the transistor TR, and the transistor TR has a gate electrode thereof connected to any of the plurality of scan lines G1 to Gn. A power-off sequence period includes: a first period T1 in which a simultaneous selection is performed where an active electrical potential is supplied to the plurality of scan lines G1 to Gn while a black-gray-level electrical potential is being supplied to the first data line S1; and a second period T2 in which the black-gray-level electrical potential is supplied to the first data line S1 with the supply of the active electrical potential to the plurality of scan lines G1 to Gn being suspended.

Referring to FIGS. 1 to 6, in the liquid crystal display device 10, the electrical potential of the pixel electrode PE of the normal pixel circuit 4 is maintained at (controlled to) the black-gray-level electrical potential in the second period T2. Therefore, even if there is a point defect shown in FIG. 5 (a pixel circuit 4D that has gate-drain short-circuiting), an irregular display (bright line) is less likely to develop upon turning off or on the power supply. Each drawing identifies the electrically floating state (high impedance state) of a conductor such as wiring by “FL.” In addition, the pixel circuit 4D having gate-drain short-circuiting is also referred to as a defective circuit 4D.

The power-off sequence period is a period in which a prescribed process is performed upon turning off the power supply of the liquid crystal display device 10. In the liquid crystal display device 10, the power-off sequence may include: a step of performing a simultaneous selection where an active electrical potential (HIGH) is supplied to the plurality of scan lines G1 to Gn while the black-gray-level electrical potential is being supplied to the first data line S1; a step of supplying the black-gray-level electrical potential to the first data line S1 with the supply of the active electrical potential to the plurality of scan lines G1 to Gn being suspended; and a step of suspending the supply of an electrical potential to the first data line S1.

Referring to FIGS. 1 and 2, the liquid crystal display device 10 may include: a TFT substrate (active matrix substrate) 7; an opposite substrate 9; a liquid crystal layer 8 residing between the TFT substrate 7 and the opposite substrate 9; and a backlight BL. The TFT substrate 7, the liquid crystal layer 8, and the opposite substrate 9 may constitute a liquid crystal panel LP. FIG. 2 shows that the TFT substrate 7 resides closer to the backlight BL than the liquid crystal layer 8 resides close to the backlight BL, which is merely illustrative. Alternatively, the opposite substrate 9 may reside closer to the backlight BL than the liquid crystal layer 8 resides close to the backlight BL.

The pixel circuit 4 may include the transistor TR and a liquid crystal capacitor LC. The liquid crystal capacitor LC may include the pixel electrode PE, an opposite electrode CE, and the liquid crystal layer 8. The liquid crystal capacitor LC may constitute a subpixel in the liquid crystal display device 10. The liquid crystal layer 8 may operate in normally black mode. The TFT substrate 7 may include the transistor TR, the pixel electrode PE, and the opposite electrode CE. The transistor TR may be of an N type. The opposite substrate 9 may be a color filter substrate. The opposite electrode CE may be provided on the opposite substrate 9.

The liquid crystal display device 10 may include a driver GD (scan driver) for driving the plurality of scan lines G1 to Gn. The driver GD may be active in the first period T1 and inactive (the driver GD is not being controlled) in the second period T2.

Referring to FIGS. 5 and 6, when the plurality of pixel circuits 4 connected to the first data line S1 include: the defective circuit 4D in which the gate electrode of the transistor TR and the pixel electrode PE are short-circuited; and a normal adjacent circuit 4C adjacent to the defective circuit 4D, the adjacent circuit 4C may be so maintained as to produce a black display in the first period T1 and in the second period T2.

The second period T2 may include a period that extends from the suspension of the supply of an active electrical potential to the plurality of scan lines G1 to Gn (suspension of the operation of the driver GD) to the turning-off of the transistor TR connected to each scan line. This configuration prevents an irregular display upon turning off or on the power supply (e.g., the plurality of pixel circuits 4 connected to the first data line S1 appear as bright lines) even in the presence of a point defect (the pixel circuit 4D which has gate-drain short-circuiting as shown in FIG. 5) because the supply of an electrical potential to the first data line S1 is suspended (the first data line S1 hence goes floating) after the transistors TR connected to the scan lines (G1 to Gn) are turned off. The plurality of scan lines G1 to Gn may be electrically floating in the second period T2.

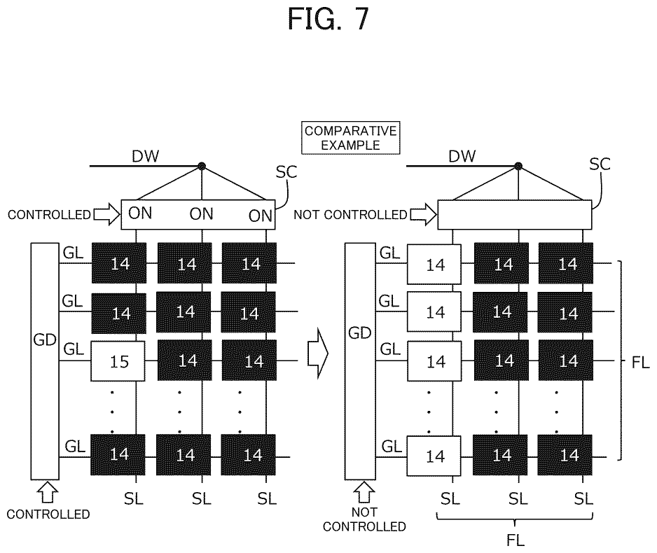

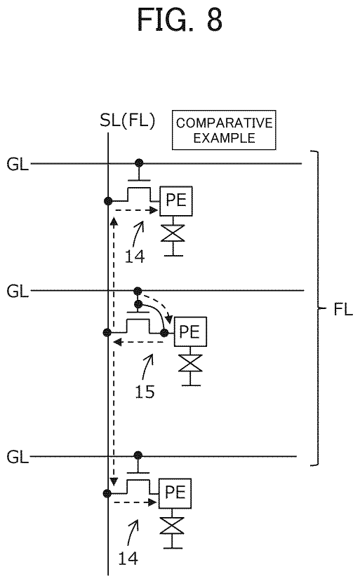

FIG. 7 is a schematic diagram of a comparative example. FIG. 8 is a schematic diagram of how a bright line can develop in a comparative example. As shown in FIG. 7 and FIG. 8, in the presence of a pixel circuit 15 with gate-drain short-circuiting, when the supply of an active electrical potential to the plurality of scan lines GL and the supply of an electrical potential to a data line SL are simultaneously suspended (in other words, the plurality of scan lines GL and the data line SL simultaneously go floating), electric charge flows from the scan line GL (electrical potential close to active HIGH) to the data line SL via a short-circuiting transistor in the pixel circuit 15, which elevates the electrical potential of the data line SL. For these reasons, a plurality of pixel circuits (14, 15) connected to the data line SL could appear as bright lines.

The transistor TR in the pixel circuit 4 may be turned off when the gate electrode falls to or below a threshold potential Vth, and the electrical potentials of the plurality of scan lines G1 to Gn may fall from an active electrical potential (HIGH) to or below the threshold potential Vth in the second period T2. The black-gray-level electrical potential supplied to the first data line S1 may be ground potential GND. The threshold potential Vth may be higher than ground potential GND. The non-active electrical potentials (LOW) of the scan lines G1 to Gn may be lower than ground potential GND.

The plurality of scan lines G1 to Gn may go floating after the first period T1. The duration of the second period T2 may be specified in accordance with the time constant of the plurality of scan lines G1 to Gn. As an example, if the time constant is large, and the electrical potentials of the scan lines G1 to Gn take time to fall from active (HIGH) to the threshold potential (the electrical potential at which the transistor TR is turned off), the duration of the second period T2 may be increased. The second period T2 may be a period that extends from the electrical floating of the scan lines G1 to Gn to the electrical floating of the first data line S1 (to the suspension of the control of a switching circuit SC).

The liquid crystal display device 10 may include: a second data line S2 and a third data line S3; the switching circuit SC; and an output line DW, wherein a data signal for a first color may be supplied to the first data line S1, a data signal for a second color may be supplied to a second data line S2, a data signal for a third color may be supplied to the third data line S3, and the first to third data lines S1 to S3 may be connected to the common output line DW via the switching circuit SC. The first color may be any one of the three colors, red, green, and blue, the second color may be one of the remaining two colors, and the third color may be the remaining one color.

The liquid crystal display device 10 may include a driver SD (data driver) for driving the output line DW, and the driver SD may be active in the first period T1 and in the second period T2 and inactive (the driver SD is not being controlled) in a third period T3 that follows the second period T2. The first data line S1 as well as other members may be electrically floating in the third period T3.

The switching circuit SC may selectively connect any one of the first to third data lines S1 to S3 to the output line DW in an ordinary display period. For example, the first data line S1 may be selected in a first one of the three divided periods obtained by dividing one horizontal scan period (1H) into three, the second data line S2 may be selected in a second divided period, and the third data line S3 may be selected in a third divided period (time division drive). This configuration enables reducing the number of data output terminals, which allows for high definition.

In the first period T1 and the second period T2 in the power-off sequence period, the black-gray-level electrical potential may be supplied to the output line DW, and the switching circuit SC may connect all the first to third data lines S1 to S3 to the output line DW. The black-gray-level electrical potential is hence supplied to all the first to third data lines S1 to S3 in the first period T1 and in the second period T2. In other words, all the first to third data lines S1 to S3 can be controlled to have the black-gray-level electrical potential, and the black-gray-level electrical potential is written to the pixel electrode PE in each pixel circuit 4 in the first period T1.

After the second period T2, the switching circuit SC may be suspended (the control of the switching circuit SC may be suspended), thereby causing the first to third data lines S1 to S3 to go floating.

The switching circuit SC may include a plurality of transistors TR1, TR2, and TR3 that are of the same type as the transistor TR in each pixel circuit 4. The first data line S1 may be connected to the output line DW via the transistor TR1, the second data line S2 may be connected to the output line DW via the transistor TR2, and the third data line S3 may be connected to the output line DW via the transistor TR3.

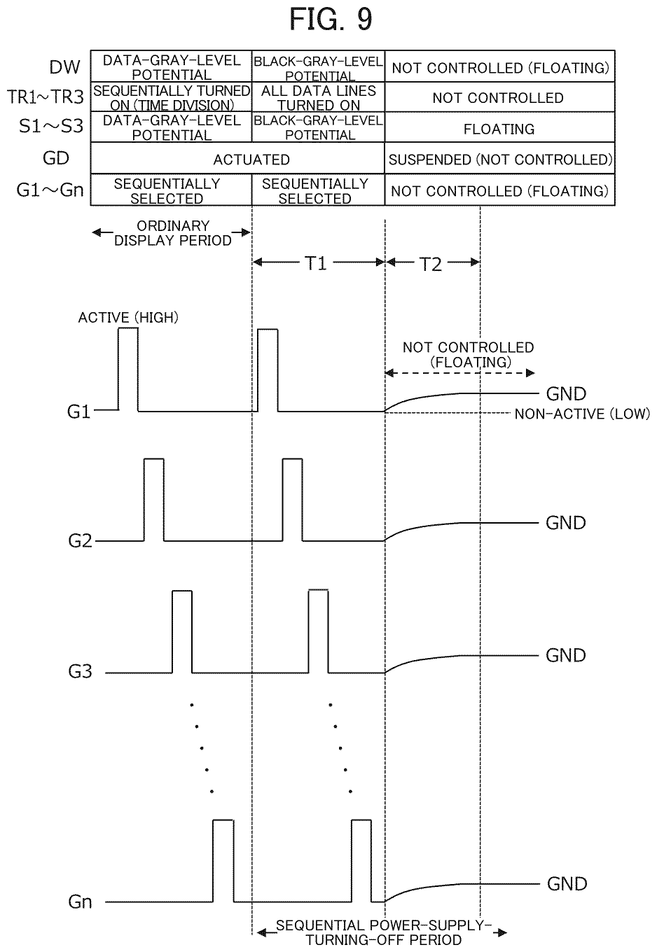

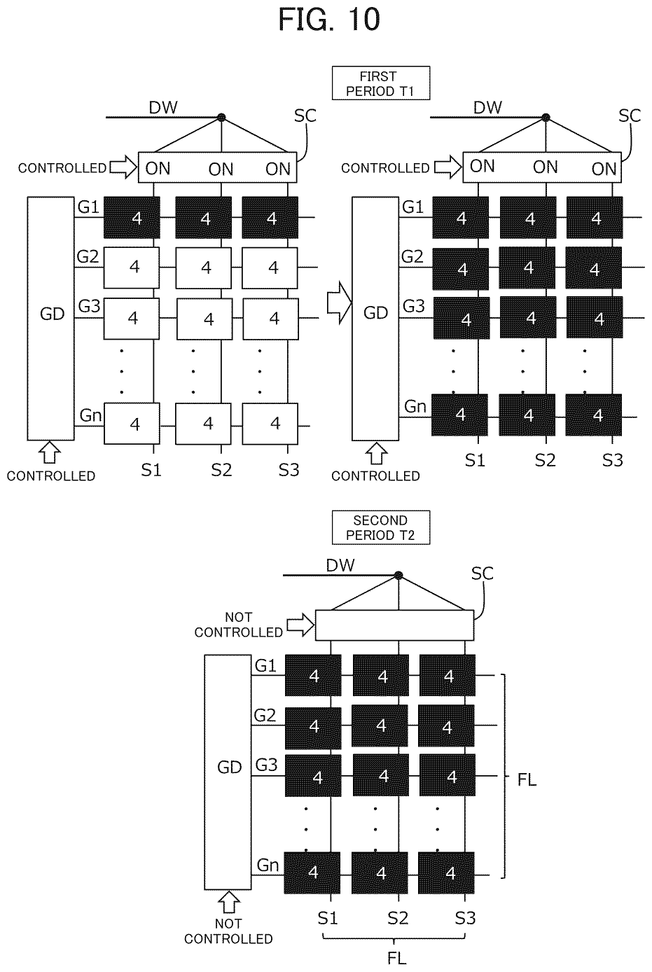

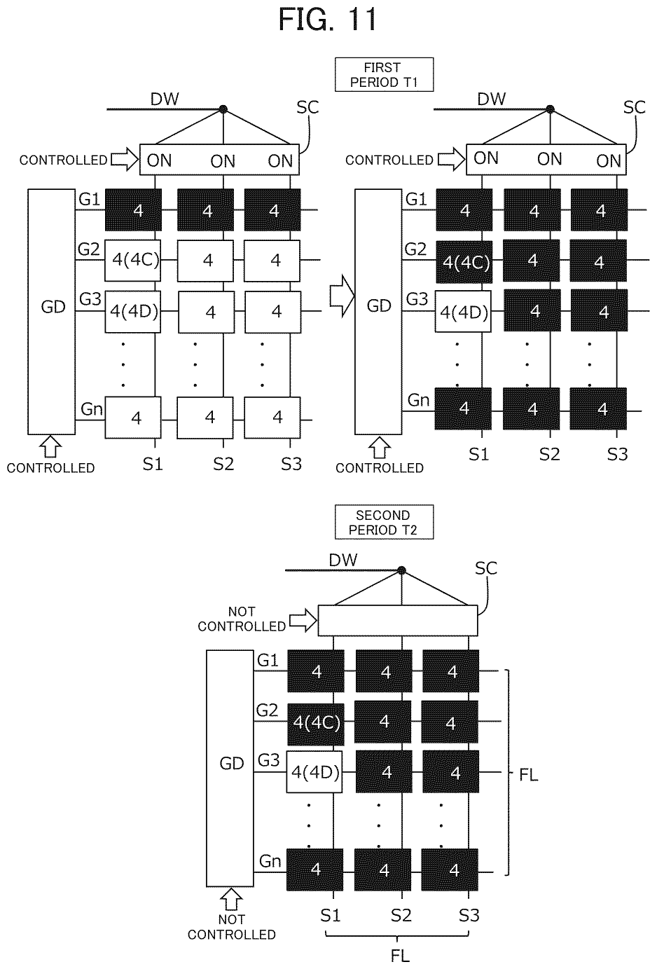

FIG. 9 is a timing chart illustrating a method of driving the present liquid crystal display device. FIG. 10 is a schematic diagram depicting a method of driving the liquid crystal display device shown in FIG. 2. FIG. 11 is a schematic diagram depicting a method of driving the liquid crystal display device shown in FIG. 5. Referring to FIGS. 9 to 11, in the liquid crystal display device 10, the power-off sequence period includes the first period T1 in which the plurality of scan lines G1 to Gn are sequentially selected while the black-gray-level electrical potential is being supplied to the first data line S1.

In this configuration, the transistor TR is turned off in the first period T1 with the black-gray-level electrical potential being written to the pixel electrode PE in the normal pixel circuit 4. Therefore, an irregular display (bright line) is less likely to develop upon turning off or on the power supply as shown in FIG. 11, even in the presence of a point defect (the pixel circuit 4D with gate-drain short-circuiting). In other words, this is because: the scan line G2 is non-active (LOW electrical potential) in a select period for the succeeding scan line G3 connected to the defective circuit 4D (a period in which the first data line S1 and the scan line G3 are short-circuited); and the scan lines G1 to Gn are non-active (LOW electrical potential) also when the first data line S1 and the scan lines G1 to Gn electrically float after the first period T1 (sequential selection of the scan lines G1 to Gn).

The power-off sequence period is a period in which a prescribed process is performed upon turning off the power supply of the liquid crystal display device 10. In the liquid crystal display device 10, the power-off sequence includes a step of sequentially selecting the plurality of scan lines G1 to Gn while the black-gray-level electrical potential is being supplied to the first data line S1. The sequential selection may be sequentially supplying, to a plurality of scan lines, a pulse (including a rise from a non-active, LOW electrical potential to an active, HIGH electrical potential and a fall from the HIGH electrical potential to the LOW electrical potential).

In the power-off sequence period shown in FIGS. 9 to 11, the non-active electrical potential (LOW) may be supplied to the plurality of scan lines G1 to Gn upon the end of the sequential selection in the first period T1. Subsequent to the first period T1, the second period T2 may be included in which the supply of an active electrical potential to the plurality of scan lines G1 to Gn is suspended. The first data line S1 and the plurality of scan lines G1 to Gn may be electrically floating in the second period T2. Referring to FIG. 11, the normal adjacent circuit 4C adjacent to the defective circuit 4D is so maintained as to produce a black display in the second period T2.

In the ordinary display period shown in FIG. 9, the switching circuit SC may selectively connect any one of the first to third data lines S1 to S3 to the output line DW. For example, the first data line S1 may be selected in a first one of the three divided periods obtained by dividing one horizontal scan period (1H) into three, the second data line S2 may be selected in a second divided period, and the third data line S3 may be selected in a third divided period (time division drive).

In the first period T1 in the power-off sequence period shown in FIG. 9, the black-gray-level electrical potential may be supplied to the output line DW, and the switching circuit SC may connect all the first to third data lines S1 to S3 to the output line DW. The black-gray-level electrical potential is hence supplied to all the first to third data lines S1 to S3 in the first period T1. In other words, all the first to third data lines S1 to S3 can be controlled to have the black-gray-level electrical potential, and the black-gray-level electrical potential is written to the pixel electrode PE in each pixel circuit 4 in the first period T1.

In FIGS. 1 and 2, the transistor TR, the pixel electrode PE, the output line DW, and the switching circuit SC (including the transistors TR1 to TR3) may be monolithically formed in the TFT substrate 7. The driver GD (scan driver), which drives the plurality of scan lines G1 to Gn, may be monolithically formed in the TFT substrate 7.

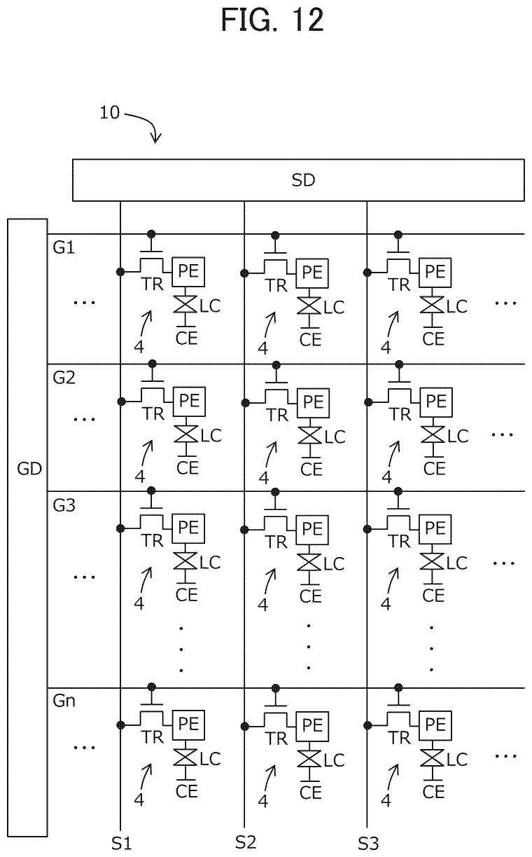

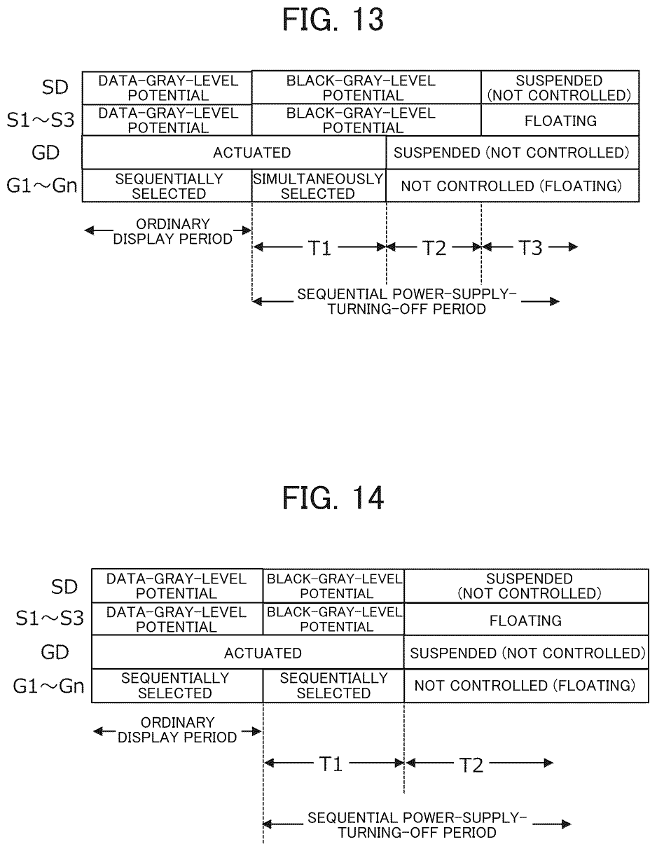

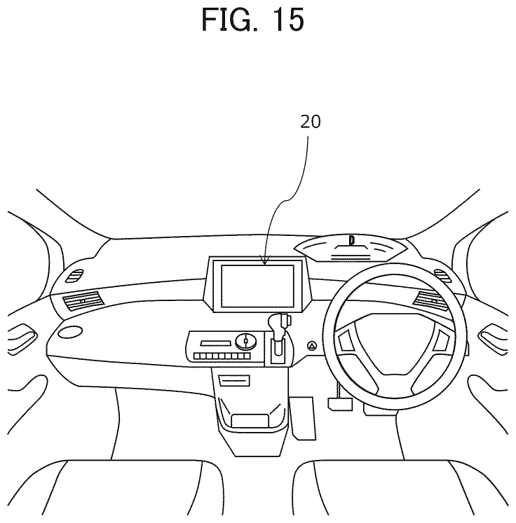

FIG. 12 is a schematic diagram of an exemplary structure of a liquid crystal display device in accordance with the present embodiment. FIGS. 13 and 14 are timing charts illustrating a method of driving the present liquid crystal display device. The liquid crystal display device 10 shown in, for example, FIG. 2 includes the output line DW and the switching circuit SC and performs time division drive, which is merely illustrative. Alternatively, the first data line S1 as well as other members may be connected to the data driver SD as shown in FIG. 12. The liquid crystal display device shown in FIG. 12 can be driven as shown in FIG. 13 or FIG. 14.

FIG. 15 is a schematic diagram of an onboard display device in accordance with the present embodiment. An onboard display device 20 may include the liquid crystal display device 10 shown in FIGS. 1 to 14.

The embodiments and examples described so far are for illustrative purposes only and is by no means intended to limit the scope of the present disclosure. It is obvious to the person skilled in the art that many modifications and variations are possible based on the description.

### Summation

A liquid crystal display device including:
a first data line;
a plurality of scan lines; and
a plurality of pixel circuits each including a transistor and a pixel electrode, wherein
in each of the plurality of pixel circuits, the pixel electrode is connected to the first data line via the transistor, and the transistor has a gate electrode connected to any of the plurality of scan lines, and
a power-off sequence period includes:
   a first period in which a simultaneous selection is performed where an active electrical potential is supplied to the plurality of scan lines while a black-gray-level electrical potential is being supplied to the first data line; and
   a second period in which the black-gray-level electrical potential is supplied to the first data line with the supply of the active electrical potential to the plurality of scan lines being suspended.

The aforementioned liquid crystal display device, wherein the second period includes a period that extends from the suspension of the supply of the active electrical potential to the plurality of scan lines to turning-off of the transistor connected to each of the plurality of scan lines.

The aforementioned liquid crystal display device, wherein the plurality of scan lines are electrically floating in the second period.

The aforementioned liquid crystal display device, wherein when the plurality of pixel circuits include: a defective circuit in which the gate electrode of the transistor and the pixel electrode are short-circuited; and an adjacent circuit that is normal and that is adjacent to the defective circuit, the adjacent circuit is maintained to produce a black display in the first period and in the second period.

The aforementioned liquid crystal display device, further including:
a second data line and a third data line;
a switching circuit; and
an output line, wherein
a data signal for a first color is supplied to the first data line,
a data signal for a second color is supplied to the second data line,
a data signal for a third color is supplied to the third data line, and
the first to third data lines are connected commonly to the output line via the switching circuit.

The aforementioned liquid crystal display device, wherein the switching circuit selectively connects any one of the first to third data lines to the output line in an ordinary display period.

The aforementioned liquid crystal display device, wherein in the first period and the second period,

the black-gray-level electrical potential is supplied to the output line, and

the switching circuit connects all the first to third data lines to the output line.

The aforementioned liquid crystal display device, wherein after the second period, the switching circuit is stopped so as to electrically float the first to third data lines.

The aforementioned liquid crystal display device, wherein the switching circuit includes a plurality of transistors of a same type as the transistor in each of the plurality of pixel circuits.

The aforementioned liquid crystal display device, wherein the plurality of scan lines electrically float after the first period.

The aforementioned liquid crystal display device, wherein the second period has a duration specified in accordance with a time constant of the plurality of scan lines.

The aforementioned liquid crystal display device, wherein the black-gray-level electrical potential is ground potential.

The aforementioned liquid crystal display device, further including a normal-black liquid crystal layer, wherein the transistor is a transistor of an N type.

The aforementioned liquid crystal display device, wherein
the transistor is turned off when the gate electrode falls to or below a threshold potential, and
electrical potentials of the plurality of scan lines fall from the active electrical potential to or below a threshold potential in the second period.

The aforementioned liquid crystal display device, wherein the threshold potential is higher than ground potential.

A liquid crystal display device including:
a first data line;
a plurality of scan lines; and
a plurality of pixel circuits each including a transistor and a pixel electrode, wherein
in each of the plurality of pixel circuits, the pixel electrode is connected to the first data line via the transistor, and the transistor has a gate electrode connected to any of the plurality of scan lines, and
a power-off sequence period includes a first period in which the plurality of scan lines are sequentially selected while a black-gray-level electrical potential is being supplied to the first data line.

The aforementioned liquid crystal display device, wherein in the first period, a non-active electrical potential is supplied to the plurality of scan lines when the sequential selection ends.

The aforementioned liquid crystal display device, wherein the power-off sequence period further includes, subsequent to the first period, a second period in which supply of an active electrical potential to the plurality of scan lines is suspended.

The aforementioned liquid crystal display device, wherein the first data line and the plurality of scan lines are electrically floating in the second period.

The aforementioned liquid crystal display device, wherein when the plurality of pixel circuits include: a defective circuit in which the gate electrode of the transistor and the pixel electrode are short-circuited; and an adjacent circuit that is normal and that is adjacent to the defective circuit, the adjacent circuit is maintained to produce a black display in the second period.

The aforementioned liquid crystal display device, further including:
a second data line and a third data line;
a switching circuit; and
an output line, wherein
a data signal for a first color is supplied to the first data line,
a data signal for a second color is supplied to the second data line,
a data signal for a third color is supplied to the third data line, and
the first to third data lines are connected commonly to the output line via the switching circuit.

The aforementioned liquid crystal display device, wherein in the first period,

the black-gray-level electrical potential is supplied to the output line, and

the switching circuit connects all the first to third data lines to the output line.

The aforementioned liquid crystal display device, further including a TFT substrate in which the pixel electrode, the transistor, the output line, and the switching circuit are monolithically formed.

The aforementioned liquid crystal display device, further including a driver monolithically formed in the TFT substrate to drive the plurality of scan lines.

An onboard display device including the aforementioned liquid crystal display device.

A method of driving a liquid crystal display device including: a first data line; a plurality of scan lines; and a plurality of pixel circuits each including a transistor and a pixel electrode, wherein in each of the plurality of pixel circuits, the pixel electrode is connected to the first data line via the transistor, and the transistor has a gate electrode connected to any of the plurality of scan lines, the method including, in a power-off sequence:
a step of performing a simultaneous selection where an active electrical potential is supplied to the plurality of scan lines while a black-gray-level electrical potential is being supplied to the first data line; and
a step of supplying the black-gray-level electrical potential to the first data line with the supply of the active electrical potential to the plurality of scan lines being suspended.

A method of driving a liquid crystal display device including: a first data line; a plurality of scan lines; and a plurality of pixel circuits each including a transistor and a pixel electrode, wherein in each of the plurality of pixel circuits, the pixel electrode is connected to the first data line via the transistor, and the transistor has a gate electrode connected to any of the plurality of scan lines, the method including, in a power-off sequence,

a step of sequentially selecting the plurality of scan lines while a black-gray-level electrical potential is being supplied to the first data line.

What is claimed is:

1. A liquid crystal display device comprising:
a first data line;
a plurality of scan lines; and
a plurality of pixel circuits each including a transistor and a pixel electrode, wherein
in each of the plurality of pixel circuits, the pixel electrode is connected to the first data line via the transistor, and the transistor has a gate electrode connected to any of the plurality of scan lines, and
a power-off sequence period includes:
a first period in which a simultaneous selection is performed where an active electrical potential is supplied to the plurality of scan lines while a black-gray-level electrical potential is being supplied to the first data line; and
a second period in which the black-gray-level electrical potential is supplied to the first data line with the supply of the active electrical potential to the plurality of scan lines being suspended.

2. The liquid crystal display device according to claim 1, wherein the second period includes a period that extends from the suspension of the supply of the active electrical potential to the plurality of scan lines to turning-off of the transistor connected to each of the plurality of scan lines.

3. The liquid crystal display device according to claim 1, wherein the plurality of scan lines are electrically floating in the second period.

4. The liquid crystal display device according to claim 1, wherein when the plurality of pixel circuits include: a defective circuit in which the gate electrode of the transistor and the pixel electrode are short-circuited; and an adjacent circuit that is normal and that is adjacent to the defective circuit, the adjacent circuit is maintained to produce a black display in the first period and in the second period.

5. The liquid crystal display device according to claim 1, further comprising:
a second data line and a third data line;
a switching circuit; and
an output line, wherein
a data signal for a first color is supplied to the first data line,
a data signal for a second color is supplied to the second data line,
a data signal for a third color is supplied to the third data line, and
the first to third data lines are connected commonly to the output line via the switching circuit.

6. The liquid crystal display device according to claim 5, wherein the switching circuit selectively connects any one of the first to third data lines to the output line in an ordinary display period.

7. The liquid crystal display device according to claim 5, wherein in the first period and the second period,
the black-gray-level electrical potential is supplied to the output line, and
the switching circuit connects all the first to third data lines to the output line.

8. The liquid crystal display device according to claim 5, wherein after the second period, the switching circuit is stopped so as to electrically float the first to third data lines.

9. The liquid crystal display device according to claim 1, wherein the plurality of scan lines electrically float after the first period.

10. The liquid crystal display device according to claim 1, wherein the black-gray-level electrical potential is ground potential.

11. The liquid crystal display device according to claim 1, wherein
the transistor is turned off when the gate electrode falls to or below a threshold potential, and
electrical potentials of the plurality of scan lines fall from the active electrical potential to or below a threshold potential in the second period.

12. The liquid crystal display device according to claim 11, wherein the threshold potential is higher than ground potential.

13. A liquid crystal display device comprising:
a first data line;
a plurality of scan lines; and
a plurality of pixel circuits each including a transistor and a pixel electrode, wherein
in each of the plurality of pixel circuits, the pixel electrode is connected to the first data line via the transistor, and the transistor has a gate electrode connected to any of the plurality of scan lines, and
a power-off sequence period includes a first period in which the plurality of scan lines are sequentially selected while a black-gray-level electrical potential is being supplied to the first data line.

14. The liquid crystal display device according to claim 13, wherein in the first period, a non-active electrical potential is supplied to the plurality of scan lines when the sequential selection ends.

15. The liquid crystal display device according to claim 13, wherein the power-off sequence period further includes, subsequent to the first period, a second period in which the supply of the active electrical potential to the plurality of scan lines is suspended.

16. The liquid crystal display device according to claim 15, wherein the first data line and the plurality of scan lines are electrically floating in the second period.

17. The liquid crystal display device according to claim 15, wherein when the plurality of pixel circuits include: a defective circuit in which the gate electrode of the transistor and the pixel electrode are short-circuited; and an adjacent circuit that is normal and that is adjacent to the defective circuit, the adjacent circuit is maintained to produce a black display in the second period.

18. The liquid crystal display device according to claim 13, further comprising:
a second data line and a third data line;
a switching circuit; and
an output line, wherein
a data signal for a first color is supplied to the first data line,
a data signal for a second color is supplied to the second data line,
a data signal for a third color is supplied to the third data line, and
the first to third data lines are connected commonly to the output line via the switching circuit.

19. The liquid crystal display device according to claim 18, wherein in the first period,
the black-gray-level electrical potential is supplied to the output line, and
the switching circuit connects all the first to third data lines to the output line.

20. A method of driving a liquid crystal display device including: a first data line; a plurality of scan lines; and a plurality of pixel circuits each including a transistor and a pixel electrode, wherein in each of the plurality of pixel circuits, the pixel electrode is connected to the first data line via the transistor, and the transistor has a gate electrode connected to any of the plurality of scan lines, the method comprising, in a power-off sequence:
a step of performing a simultaneous selection where an active electrical potential is supplied to the plurality of scan lines while a black-gray-level electrical potential is being supplied to the first data line; and
a step of supplying the black-gray-level electrical potential to the first data line with the supply of the active electrical potential to the plurality of scan lines being suspended.
